(19) United States
(12) Patent Application Publication
(10) Pub. No.: US 2002/0050213 A1
(43) Pub. Date: May 2, 2002

(54) Method and apparatus for romantic sharing of food

(76) Inventor: Christopher Erwin, Castro Valley, CA (US)

Correspondence Address: GREGORY SCOTT SMITH, P O BOX 2192, FREMONT, CA, 94536

(21) Appl. No.: 10/000,679

(22) Filed: Oct. 30, 2001

Related U.S. Application Data
(60) Provisional application No. 60/244,137, filed on Oct. 30, 2000.
(60) Provisional application No. 60/244,141, filed on Oct. 30, 2000.

(51) Int. Cl. A23B 4/02; A23L 1/00

(52) U.S. Cl. 99/494; 99/353

(57) ABSTRACT

The present invention is a food sharing including in combination, a holder having a proximal end for grasping by one or more users or participants, a distal end for holding a preferably replaceable food, and a design or configuration allowing multiple participants to have equal simultaneous access to the food. The food has at least one break zone allowing for at least two portions with approximately equal size segments. The invention also includes a unique method for sharing food.

### CROSS REFERENCE TO RELATED APPLICATIONS

Benefit of the priority of the Oct. 30, 2000 filing date of provisional application Ser. No. 60/244,137 is hereby claimed. Also claimed is Benefit of the priority of the Oct. 30, 2000 filing date of provisional application Ser. No. 60/244,141.

### FIELD OF THE INVENTION

The present invention is a device for sharing food comprising in combination, a holder having a proximal end for grasping by one or more users or participants, a distal end for holding a preferably replaceable food, and a design or configuration allowing at least two participants to have equal preferably simultaneous access to the food. The invention also includes a unique method for sharing food.

### BACKGROUND OF THE INVENTION

The use of an elongate object such as a stick to hold food has been done since early human times. Examples of food placed on a stick and then eaten include Shish kabobs, lollipops, POPSICLES™, and corn dogs. In the prior art, the food on the stick can be replaceable, as in a shish kabob; or the food is consumed and the stick discarded, as in a lollipop. Generally, these foods have been intended to be eaten by a single individual at a time. In order to share the food, individuals must take turns eating from the stick, or portions must be broken free from the stick and distributed. Breaking pieces from the food requires handling of the food, which may be messy or unsanitary. Also, in some cases it may be difficult to break the food in a manner allowing control of the size of the portions.

Sharing food has often been used to demonstrate both commitment and affection. For example, many a business deal or marriage proposal has been discussed and/or announced at a dinner party, restaurant, or other food sharing occasion. People who are, or wish to be, romantically involved often share candy of some sort. The phrase, “sharing a kiss” has more than one possible meaning: besides the obvious, it can also mean to share a small sweetmeat or confection.

There has never been a candy or other food product designed specifically to combine into one action these two often-concurrent activities.

What is needed is a new approach for people to interact romantically using food to draw them together, and a new food and food holder configuration that facilitates the new approach.

### SUMMARY OF THE INVENTION

The present invention is a device for sharing food. The invention comprises a combination of a stick or holder and an edible food placed on it. In the preferred embodiment, the food is replaceable, however, in alternate embodiments, the invention may be designed for a single use. The food, such as candy, is designed to be shared between two or more people with each participant allowed equal, simultaneous access to the food. The invention further includes a method comprising unique steps for the sharing of food.

The intent of the invention is to bring people together over food in a new way. In a preferred embodiment the replaceable food is a candy and when the people come together, as in a male and female, then the biting and breaking of the candy can lead to fun moments. This new genre of candy, called “Kissing Candy”, will lead to smiles, and possibly kisses. Thus, the invention may be favored by lovers of all ages.

This novel invention and the associated novel method of bringing people together are open to many different types of food products and not restricted to candy. The invention and method are intended to include soft foods and liquids, and is intended for, but not limited to, use by two participants.

Other features and advantages of this invention will become apparent upon reading the following specification, which, along with the drawings, describes and discloses a preferred and alternative embodiment of the invention in detail.

### LIST OF DRAWINGS

A better understanding of the present invention will be had upon reference to the accompanying drawings, in which like numerals refer to like parts in the several views and in which:

FIG. 1 is a component view of the preferred embodiment of the food holder and replaceable food according to the present invention

FIG. 2 is a view of the preferred embodiment for the replaceable food using the present invention

FIG. 3 is a view of the food holder

FIG. 4 is a side view of the food holder

FIG. 5 is a top view of the food holder

FIG. 6 is of the food holder with participants having equal access to the food

### DETAILED DESCRIPTION

The present invention makes available a new approach for people to interact romantically, using food to draw them together. This invention is both a device and a method for using the device. The device generally comprises a preferably replaceable edible item, such as a food, and a holder for holding the edible item. In a preferred embodiment, two people approach the edible item, a candy for example, then bite down preferably approximately simultaneously. When the candy breaks in approximately two equal sized pieces, a smile and perhaps kisses result. Thus, the invention may be favored by lovers of all ages.

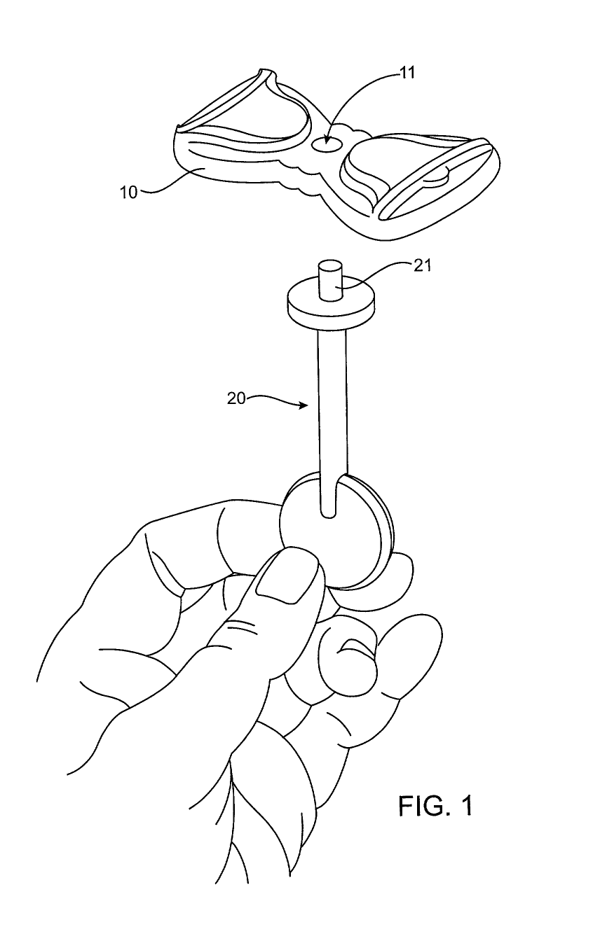

Shown in FIG. 1 is a preferred embodiment of the invention comprising a holder 20 and food 10. Food 10 is taken from a package and its center hole 11 is placed onto post 21 of holder 20. The purpose of post 21 on holder 20 is to allow food 10 to remain attached to holder 20 as the holder 20 is moved.

Although a preferred holder 20 embodiment has been disclosed in FIG. 1 for holding the food 10, many holding configurations may be useable, and should be considered within the scope of this invention.

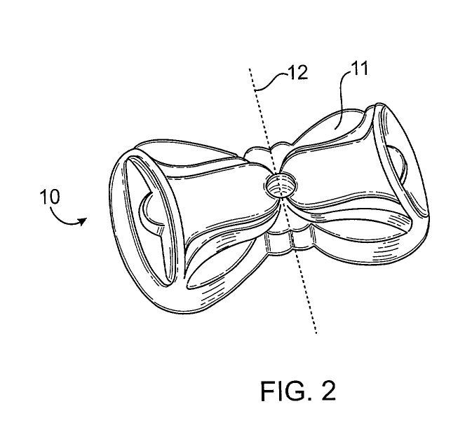

Shown in FIG. 2 is a preferred embodiment of the food 10 to be shared among two or more participants. In the preferred embodiment, the food 10 is a chocolate of average density. Hole 11 allows for the food 10 to remain stable on the holder as it is moved to the participants. In the preferred embodiment, the food 10 shape narrows around the center point of the food 10 forming a brittle or frangible area 12 allowing for the food 10 to break easily into in approximately equal portions. In alternate embodiments, any other known means for creating a weak or brittle preferred break zone maybe used.

In the preferred embodiment shown, the food 10 is formed to allow the food 10 to break into two portions, which allows for two participants in the food sharing. In alternate embodiments, the candy may be formed to allow for an increased number of portions, which then allows for more participants in the food sharing. For example, in an alternate embodiment, the food 10 may be cross-shaped .

Although the food 10 is chocolate in the preferred embodiment, in alternate embodiments, the food 10 may comprise virtually any edible material without departing materially from the teachings of this invention.

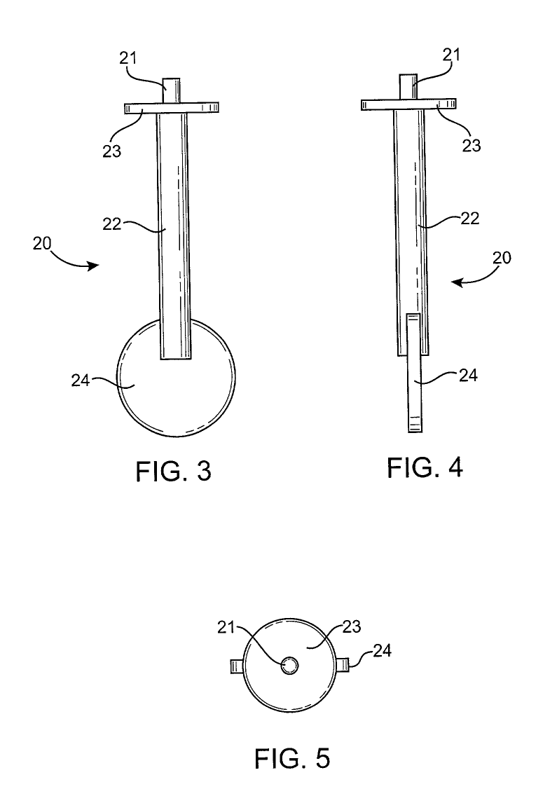

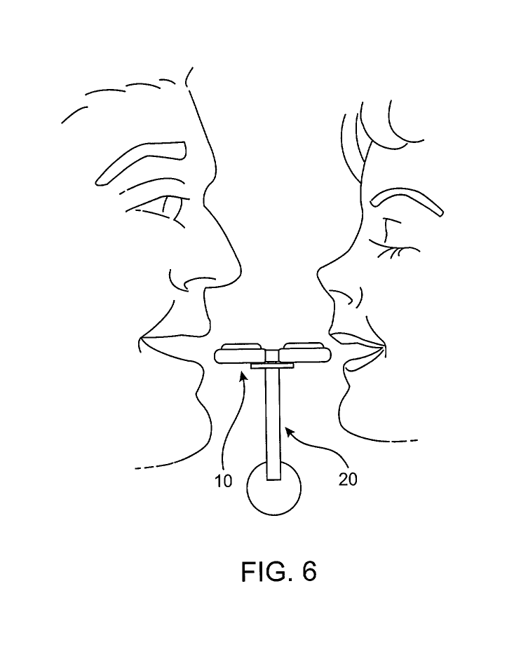

FIG. 3 shows the front view of a preferred embodiment of the holder 20, which has a preferred overall length of 3.5 inches. In the preferred embodiment, a paddle 24 at the proximal end of the holder allows for grasping by one or more of the participants. At the distal end of holder 20 is food support 23 allowing the food to remain at the distal end of the holder 20. There is a support stem 22 between the paddle 24 and the holding means or food support 23. Post 21 inhibits the food from moving off of the holder 20 as the holder 20 is moved near the participants.

Shown in FIG. 4 is a side view of holder 20. Those skilled in the art will appreciate that other sizes, shapes and configurations of the holder 20 are readily usable without departing from the spirit of the invention. For example, in the preferred embodiment, the support stem 22 is thin around its longitudinal axis but may be thick in alternate embodiments. Also, in this preferred embodiment the paddle 24 is circular with other geometric forms possible in alternate embodiments.

Shown in FIG. 5 is a top view of holder 20. Post 21 and food support 24 are circular in the preferred embodiment with other shapes possible in alternate embodiments. In still other embodiments, more than a single post 21 is possible for supporting the food.

In the preferred embodiment the holder 20 is nonedible. However, alternate embodiments allow for edible holders. In the preferred embodiment the food 10 is solid, however, in alternate embodiments, the food may have virtually any selected fillings.

The method associated with this invention can be understood by referring to FIG. 7. Food 10 and holder 20 are acquired and made ready. The method involved in the preferred embodiment is described in the following steps:

a) Food 10 is placed on holder 20.

b) At least one of the participants picks up holder 20 and brings it to an appropriate height for biting food 10.

c) At least two participants gather around the holder 20.

d) Participants approximately simultaneously bite into food 10.

e) Food 10 preferably breaks into approximately equal portions.

Although exemplary embodiments of the invention have been described in detail above, those skilled in the art will readily appreciate that many additional modifications are possible without departing materially from the novel teachings and advantages of the invention. For example, different food types, food forms, as well as the size and shape of the food holders are possible.

What is claimed is:

1. A food sharing device comprising:
a holder having a longitudinal axis, a proximal end for grasping, and a distal end for holding an edible item, said edible item being coupled to said distal end of said holder said edible item comprising at least one weakened break zone,
psaid food sharing device being configured to be approached from at least a first direction and second direction such that said edible item is approximately equally accessible from each said direction.

2. The food sharing device of claim 1, wherein said edible item is removably coupled to said distal end of said holder.

3. The food sharing device of claim 1, wherein said edible item comprises a first portion and a second portion.

4. The food sharing device of claim 3, wherein said break zone is positioned between said first portion and said second portion of said edible item.

5. The food sharing device of claim 1, wherein said holder is reusable.

6. The food sharing device of claim 1, wherein said holder is edible.

7. The food sharing device of claim 1 wherein said food is removably coupled to said distal end of said holder.

8. A food sharing device comprising in combination:
a holder having a longitudinal axis, a proximal end for grasping, and a distal end comprising a holding means, and
an edible item, said edible item configured to removably couple to said holding means of said holder,
wherein said food sharing device may be approached from at least a first and second direction such that the edible item is approximately equally accessible from each said direction.

9. The food sharing device of claim 8, wherein said edible item comprises a first portion and a second portion.

10. The food sharing device of claim 9, further comprising a break zone between said first portion and said second portion of said edible item.

11. The food sharing device of claim 8, wherein said holder is reusable.

12. The food sharing device of claim 8, wherein said holder is edible.

13. The food sharing device of claim 8, wherein said edible item is a confectionery product.

14. The food sharing device of claim 8, wherein said edible item comprises chocolate.

15. A method for sharing food among participants, the method comprising the steps of:
(a) providing a holder having a longitudinal axis, a proximal end for grasping, and a distal end for holding an edible item, said edible item comprising at least one weakened break zone,
(b) having at least one of the participants grasp the proximal end of the holder;
(c) bringing said participants around said edible item;
(d) having the participants bite into said edible item approximately simultaneously;

16. The method of claim 15, further comprising the step of: (e) breaking said food item into approximately equal portions.

17. The method of claim 15, wherein said step (a) comprises the sub steps of: (a1) providing a holder having a longitudinal axis, a proximal end for grasping, and a distal end for holding an edible item, (a2) coupling a replaceable edible item to said distal end of said holder, said edible item comprising at least one preferred break zone.
